(19) United States
(12) Patent Application Publication
(10) Pub. No.: US 2007/0164099 A1
(43) Pub. Date: Jul. 19, 2007

(54) INTEGRATED CARD SYSTEM AND METHOD

(75) Inventors: Daniel J. Neistadt, Las Vegas, NV (US); Omar F. Khandaker, Las Vegas, NV (US); Rick L. Willard, Las Vegas, NV (US)

Correspondence Address: AXIOS LAW GROUP, 1725 WESTLAKE AVENUE NORTH, SUITE 150, SEATTLE, WA, 98109, US

(73) Assignee: WOW! TECHNOLOGIES, INC., Las Vegas, NV (US)

(21) Appl. No.: 11/307,027

(22) Filed: Jan. 19, 2006

(51) Int. Cl. G06K 5/00; G07F 19/00

(52) U.S. Cl. 235/380; 235/379

(57) ABSTRACT

An integrated card system providing multiple payment and loading mechanisms is provided herein.

### FIELD

The present invention generally relates to payment cards and, more particularly, to an integrated payment system.

### BACKGROUND

Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”), consisting of a few computers or workstations and related devices, to a wide area network (“WAN”), which interconnects computers and LANs that are geographically dispersed, to a remote access service, which interconnects remote computers via temporary communication links. An internetwork, in turn, is the joining of multiple computer networks, both similar and dissimilar, by means of gateways or routers that facilitate data transfer and conversion from various networks. A well-known abbreviation for the term internetwork is “internet.” As currently understood, the capitalized term “Internet” refers to the collection of networks and routers that use the Internet Protocol (“IP”), along with higher-level protocols, such as the Transmission Control Protocol (“TCP”) or the Uniform Datagram Packet (“UDP”) protocol, to communicate with one another.

Debit cards and gift cards are also well known in the art. Such cards are typically linked to a user's bank account or are purchased from a vendor and come in fixed value increments, for example, $10, $20, and $50. A $10 card provides the customer with $10 of purchasing power utilizing an existing debit card system. In the operation of prior art systems, cards are batch activated by the card provider in a limited number of predetermined values. A customer purchases one of these pre-activated cards by paying a fee. The cards typically include a predetermined identification code.

Such systems have proved commercially successful and desirable for a number of reasons. Gift cards allow customers to present recipients of gifts with a convenient and easy to use payment mechanism. However, once the card has been used by the recipient, its usefulness is exhausted, and it is generally thrown away.

Additionally, many merchants have little or no incentive to sell cards, and neither do other parties in the supply chain system. Current debit card and gift card technologies do not allow for distributing fees associated with these cards to a wide audience to create incentives to distribute the cards.

Furthermore, many debit cards are limited in the types of financial transactions (and networks) they may employ.

### BRIEF DESCRIPTION OF THE DRAWINGS

FIG. 1 is a pictorial diagram of a number of interconnected devices that provide a connected point of sale device card loading functionality in accordance with various embodiments.

FIG. 2 is a block diagram of a card-managing server device that provides an exemplary operating environment for one embodiment.

FIG. 3 is an exemplary diagram of a card reader device that provides an exemplary operating environment for one embodiment.

FIGS. 4a-b are exemplary diagrams of a integrated card in accordance with various embodiments.

FIG. 5 is a diagram illustrating the actions taken by devices in an integrated card system for processing an internal transaction in accordance with one embodiment.

FIG. 6 is a diagram illustrating the actions taken by devices in an integrated card system for processing a local transaction in accordance with one embodiment.

FIG. 7 is a diagram illustrating the actions taken by devices in an integrated card system for processing a remote transaction in accordance with one embodiment.

FIG. 8 is a diagram illustrating the actions taken by devices in an integrated card system for processing a transfer transaction in accordance with one embodiment.

FIG. 9 is a flow diagram illustrating a card reader routine in accordance with one embodiment.

FIG. 10 is a flow diagram illustrating a transaction routing routine in accordance with one embodiment.

FIG. 11 is a flow diagram illustrating a transaction processing routine in accordance with one embodiment.

FIG. 12 is a pictorial diagram of a number of interconnected devices that provide ACH transactions in accordance with various embodiments.

### DETAILED DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. Those of ordinary skill in the art will appreciate that other embodiments, including additional devices, or combinations of illustrated devices, may be added to, or combined, without limiting the scope to the embodiments disclosed herein.

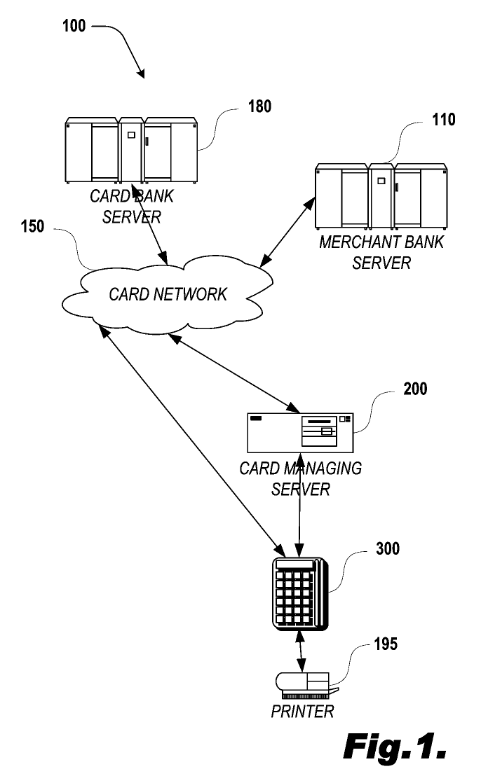

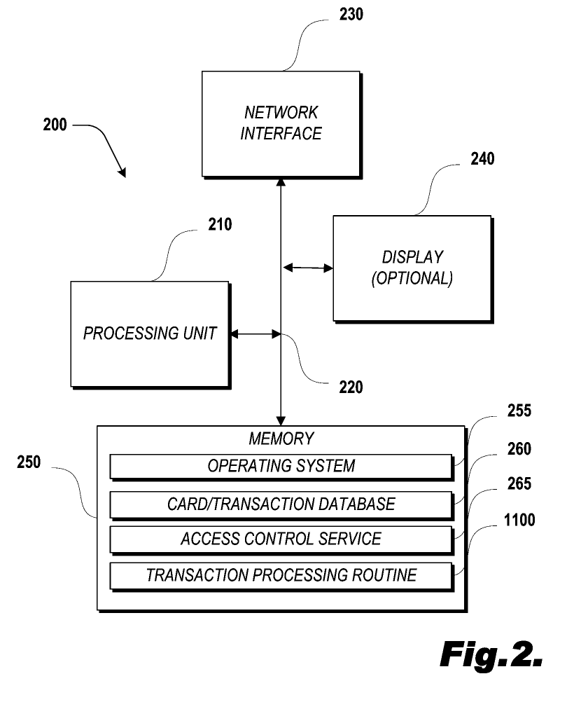

FIG. 1 illustrates an exemplary integrated card system 100 having a number of devices used in exemplary embodiments. FIG. 1 illustrates a card reader 300 (optionally having a printer 195), connected to a card-managing server 200, illustrated in FIG. 2 and described below, and a card network 150, such as a network provided by any of the well known debit/credit card transaction network providers (e.g., Star, Cirrus, Visa, MasterCard, American Express, Diners Club, etc.). Also in communication with the card network 150 is a card bank server 180 and a merchant bank server 110. In alternate embodiments, there may be a plurality bank servers, or even that the role of the card bank server 180 may be performed by another device such as merchant bank server 110. In further embodiments, still additional devices (not shown) may be utilized in the integrated card system 100.

FIG. 2 illustrates several of the key components of the card-managing server 200. In some embodiments, the card-managing server 200 may include many more components than those shown in FIG. 2. However, it is not necessary that all of these generally conventional components be shown in order to disclose an illustrative embodiment. As shown in FIG. 2, the card-managing server 200 includes a network interface 230 for connecting to the card network 150. Those of ordinary skill in the art will appreciate that the network interface 230 includes the necessary circuitry for such a connection and is constructed for use with the appropriate protocol.

The card-managing server 200 also includes a processing unit 210, a memory 250 and may include an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores the program code necessary for a transaction processing routine 1100, in addition to the card/transaction database 260 and access control service 265 (e.g., for programming and control of card-based door locks and the like). In addition, the memory 250 also stores an operating system 255. It will be appreciated that these software components may be loaded from a computer readable medium into memory 250 of the card-managing server 200 using a drive mechanism (not shown) associated with a computer readable medium, such as a floppy disc, tape, DVD/CD-ROM drive or via the network interface 230.

Although an exemplary card-managing server 200 has been described that generally conforms to conventional general purpose computing devices, those of ordinary skill in the art will appreciate that a card-managing server 200 may be any of a great number of devices capable of communicating with the card network 150 or with the card reader 300.

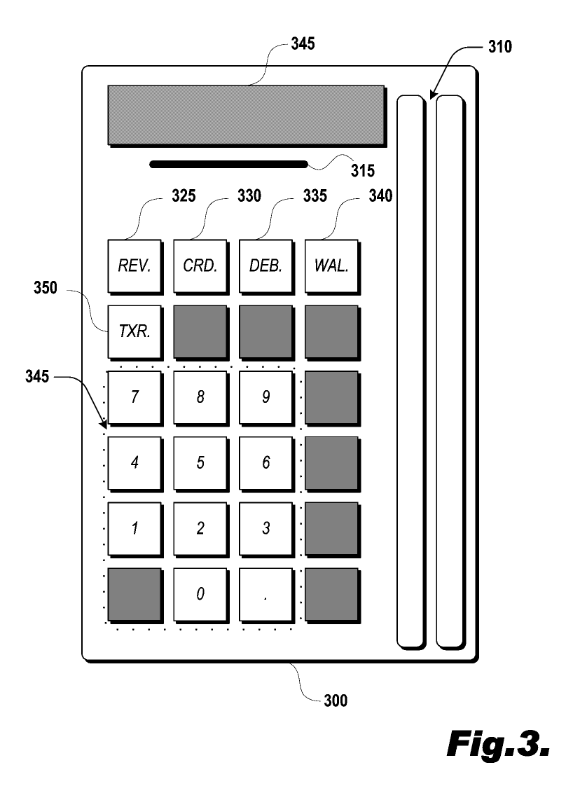

FIG. 3 depicts an exemplary card reader device 300 for use in various embodiments. The card reader device 300 may include a card swipe 310, card slot 315, credit button 330, debit button 335, wallet button 340, transfer button 350, transaction reversal button 325, display 345 and numeric entry buttons 355. Although an exemplary card reader device 300 has been described and shown in FIG. 3, those of ordinary skill in the art will appreciate that card reader devices may take many forms and may include many additional components other than those shown in FIG. 3. For example, the card reader device 300 may include a connection to a printer 195 for printing information received at the card reader device 300. In alternate embodiments, the card reader 300 may be a door lock, automated teller machine, point-of-sale device, personal computer, slot machine or the like.

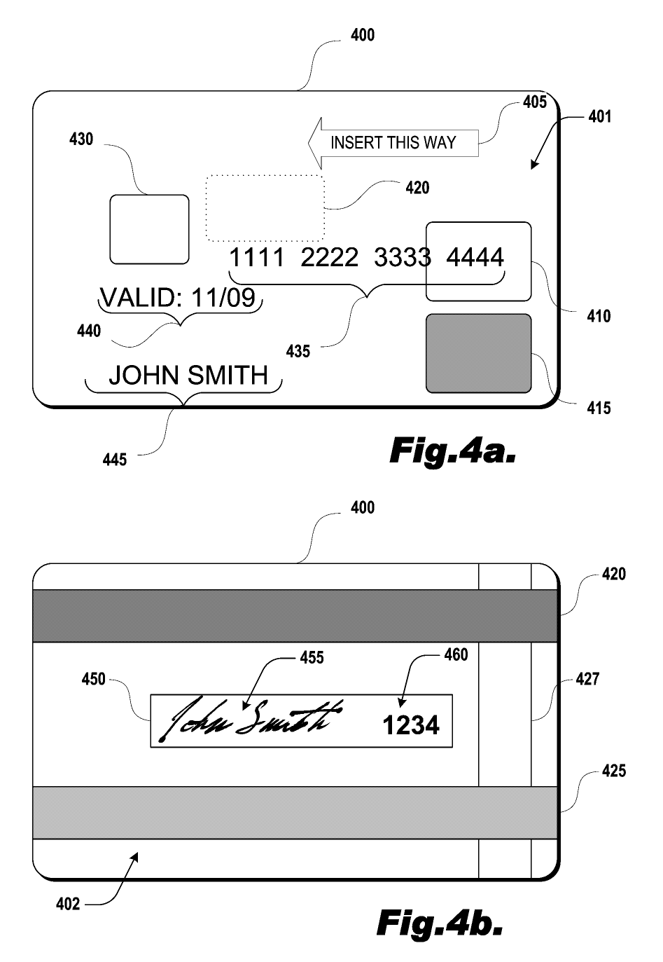

FIGS. 4a-b illustrate an exemplary integrated card 400 suitable for use in various embodiments. FIG. 4a illustrates an exemplary front face 401 of the integrated card 400. FIG. 4b illustrates and exemplary back face 402 of the integrate card 400. The integrated card 400 may include one or more magnetic strips 420, 425, 427, a smart card chip interface 430, embossed account numbers 435 and/or fraud prevention components 410 (e.g., decals, photographs, holograms, etc.) as well as a card type logo 415. Likewise, in some embodiments, the integrated card 400 may contain a card user's name 445 and an expiration date 440. In some embodiments, the integrated card 400 may include any of the magnetic strips 420, 425, 427, smart card chip interface 430, and embossed numbers 435 to be effective as a payment card. It will further be appreciated that additional means of storing information or providing information on the card may also be used. In one exemplary embodiment, a security code 460 may be printed or embossed on the integrated card 400 as well. Additionally, in some embodiments, the integrated card 400 may have a signature block 450 having a user's signature 455.

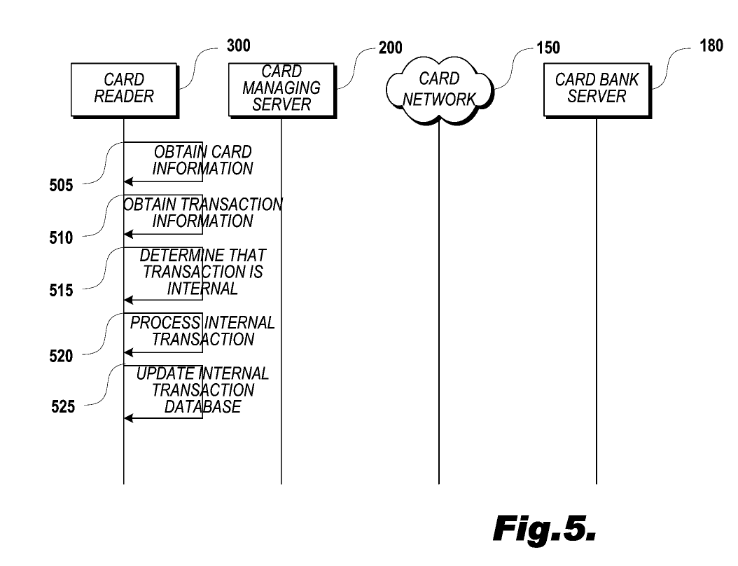

FIGS. 5-8 illustrate exemplary steps to process transactions in the integrated card system 100. Some transactions in the integrated card system 100 may be more networked than others. Accordingly, in some embodiments, the number of devices used to process a transaction is kept to minimum.

FIG. 5, for example, illustrates an exemplary “internal” transaction where the steps of the transaction take place at a card reader 300 device. The internal transaction begins with the card reader 300 obtaining 505 card information from a integrated card 400. Next, the card reader 300 obtains 510 transaction information. In some embodiments, transaction information may be implicit in the card reader 300 or the integrated card 400. For example, if the card reader 300 is a card door lock, then inserting a integrated card 400 would imply that a local transaction to the card lock (e.g., locking or unlocking the door lock or retrieving information from the door lock card reader, or the like). Likewise, inserting a integrated card 400 into a gambling device card reader 300 would imply that accessible financial data on (or available to) the integrated card 400 would be available to the gambling device card reader 300 as a payment mechanism for playing/gambling on the device.

In any case, the card reader 300 determines 515 that the transaction is an internal transaction and processes 520 the internal transaction. (e.g., unlocks the door, provides a payment to a gambling device, transferred information from or to the card reader 300 or other device). The card reader 300 next updates 525 an internal transaction database (not shown) to keep track of transactions that have occurred at the card reader 300.

While a number of exemplary internal transactions and types of card reader 300 have been identified, it will be apparent that in alternate embodiments that other types of card readers 300 may process still other forms of internal transactions. For example authentication of a user from information provided at the card reader 300 and/or from the integrated card 400, staring a vehicle, transferring data from one integrated card 400 to another and the like.

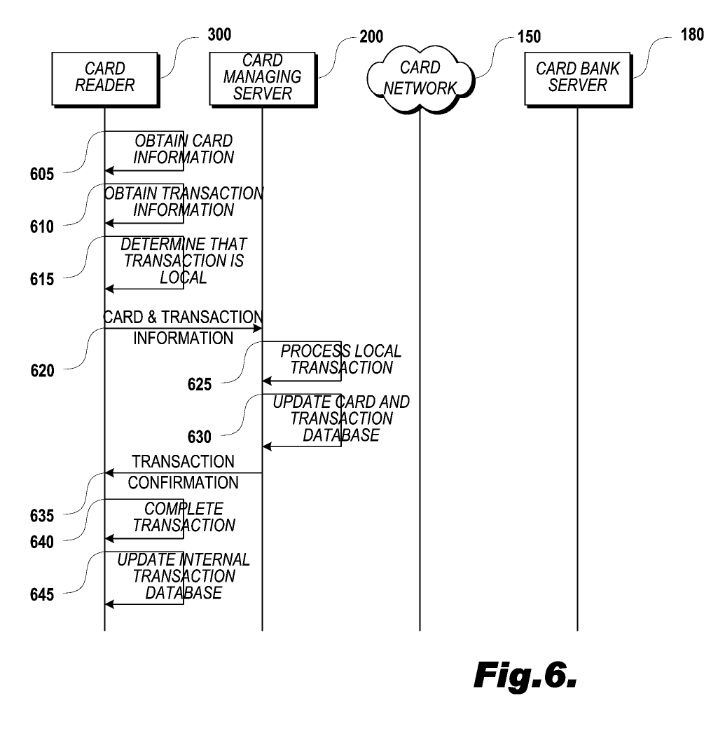

FIG. 6 illustrates alternate card transaction with communications between a card reader 300 and a card-managing server 200. Such transactions may be referred to as “local” transactions as they may stay within a local communications network In one exemplary embodiment, the local communications network is specific to a merchant or to a group of merchants. However the term “local” does not necessarily imply a LAN, however the local communications network may be a LAN.

The exemplary local transaction begin with a card reader 300 obtaining 605 card information and transaction information 610. As noted above, transaction information may be implicit in the type of card reader 300 or may be specified at the card reader 300. For example a user and/or operator may select a credit transaction by pressing the credit key 330 on the card reader 300 to indicate that they want a merchant credit transaction. Once it has been determined 615 that the transaction is local, the card reader 300 sends 620 card and transaction information to the card-managing server 200. The card-managing server 200 processes 625 the local transaction and updates 630 a card/transaction database 260. Next, the card-managing server 200 confirms 635 the transaction to the card reader 300. Next, the card reader 300 may then complete 640 the transaction. Optionally, the card reader may also update 645 an internal transaction database.

Exemplary transactions that may be performed as “local” transactions may include such transactions as merchant based credit transactions (e.g., where a merchant is acting as a credit issuer on their own behalf, such as a hotel allowing room charges or a phone company allowing telephone calls to a phone card that will later be billed for the phone services and the like).

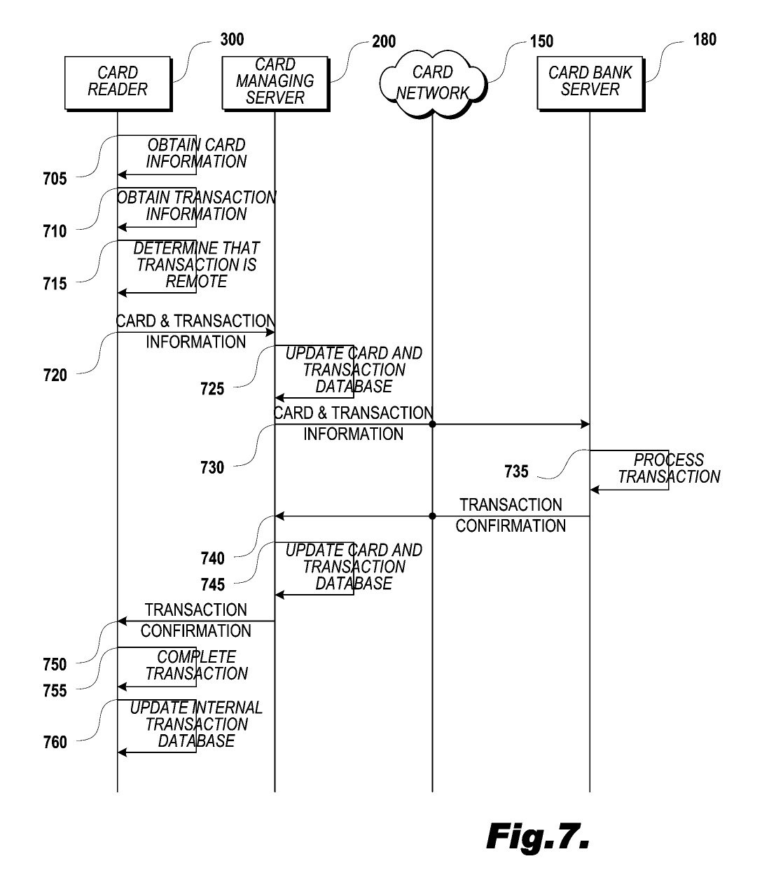

In a still further embodiment illustrated in FIG. 7, more devices may be employed in a “remote” transaction. Remote transactions are those types of transactions that are performed outside the control of the merchant (e.g., a card issuer) and/or outside a local network. In FIG. 7, card information is obtained 705 along with transaction information 710. Upon determining 715 that the transaction is a remote transaction, card and transaction information are sent 720 from the card reader 300 to the card-managing server 200. The card-managing server 200 updates 725 the card/transaction database 260 (e.g., to indicate the beginning of a remote transaction) and sends 730 card and transaction information over a card network 150 to a card bank server 180.

In alternate embodiments, the card-managing server 200 may send card and transaction information to other appropriate devices (not shown).

The card bank server 180 processes 735 the remote transaction and returns 740 a transaction confirmation via the card network 150 to the card-managing server 200. The card-managing server 200 updates 745 the card/transaction database 260 (e.g., to indicate the completion of the remote transaction by the card bank server 180) and returns 750 a transaction confirmation to the card reader 300. The card reader 300 may then complete 755 the transaction and optionally update 760 an internal transaction database to reflect the completed transaction.

It will be appreciated that in some embodiments, such as a conventional debit card transaction, that transaction communications may bypass the card-managing server 200 and communicate directly with the card bank server 180. However, in other embodiments it may be appropriate for the card-managing server 200 to maintain records of remote transactions and accordingly the communications may include the card-managing server 200.

In additional embodiments, the transactions may include a mixture of internal, local and/or remote transactions. For example the integrated card 400 allow a user to transfer data (e.g., information, funds, access codes, and the like) from one type of device/account to another.

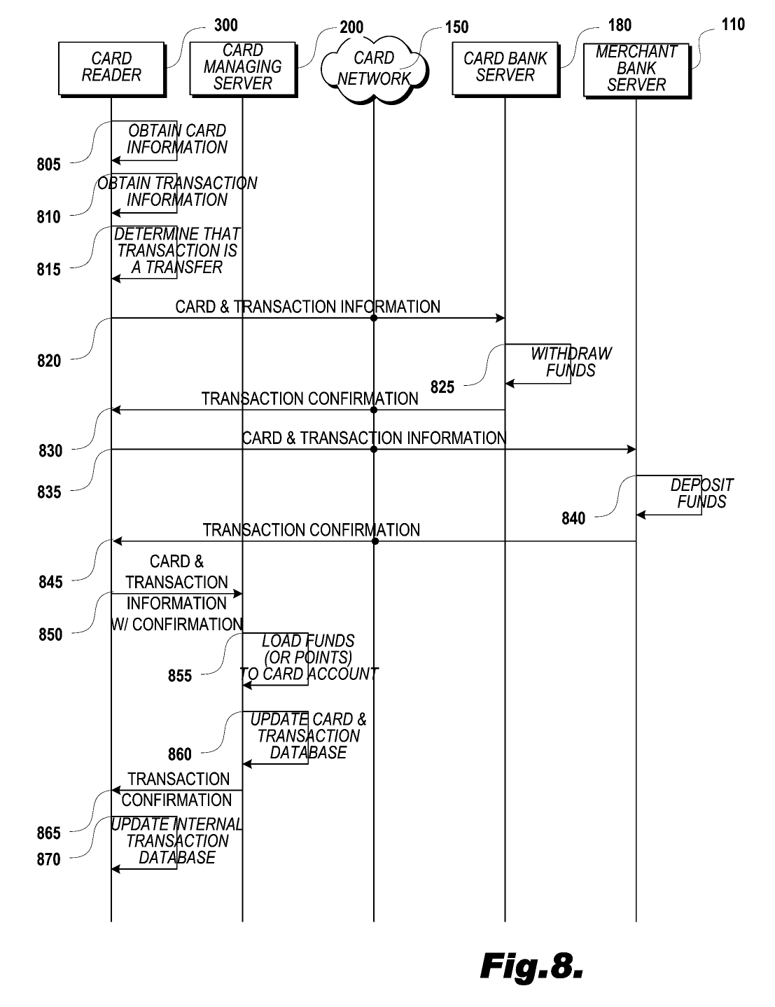

In the exemplary embodiment illustrated that in FIG. 8, a user is transferring funds from a debit card account at a card bank server 180 to local fund associated with their integrated card 400. This transaction is accomplished by depositing funds at a merchant bank server 110 that authorizes the card-managing server 200 to issue the local funds (or points). In some embodiments, the locals funds may be in an alternate currency designated by a merchant. For example, a merchant may issue points to a user that allow for payments to the merchant for goods and/or services. Such points may be purchases by the user (e.g., using a transfer scenario described below) or may be issued to the user by the merchant as an incentive for the user to continue a relationship with the merchant. For example, a hotel may issue “points” to a customer that may be used for food, gift shopping and services while at the hotel or related businesses. In some scenarios, the user may be offered discounts if they pay with points, thereby passing along potential saving to both the user and merchant (due to reduced processing costs).

The transfer illustrated in FIG. 8 begins with the card reader 300 obtaining 805 card information. The card reader 300 also obtains 810 transaction information and determines 815 that the transaction is a transfer transaction. In one exemplary embodiment a user or operator may select a transfer button 350 on the card reader 300 to indicate that the transaction is a transfer from the integrated card's associated debit account by selecting a debit button 335 to a merchant credit (or point) account by selecting the credit button 330 on the card reader 300. The transferred amount could be designated using the numeric keys 345.

The card and transaction information (including transfer origin and destination information) is sent 820 from the card reader 300 to a card bank server 180 via a card network 150. Using conventional debit card processing, the card bank server 180 withdraws 825 funds from a debit card account associated with the integrated card 400 and returns 830 a transaction confirmation via a card network 150 to the card reader 300. The card reader 300 may optionally indicate (not shown) a transaction confirmation, however, the card reader 300 communicates 835 the card and transaction information including the transaction confirmation via that card network 150 to a merchant bank server 110 to deposit a like amount of funds 840 (note there may be one or more transaction fees associated with this portion of the transaction for either one or more of the withdrawals and/or deposits of funds). The merchant bank server 110 returns a transaction confirmation 845 via the card network 150 to the card reader 300. Next, the card reader 300 communicates 850 the card and transaction information along with the merchant bank server's confirmation to the card-managing server 200. The card-managing server 200 loads 855 funds (or points) to a merchant credit account associated with the user's integrated card 400. Next, the card-managing server 200 updates 860 the card/transaction database 260 to reflect the loaded funds and sends 865 a transaction confirmation back to the card reader 300. The card reader 300 may optionally update 870 an internal transaction database to indicate or keep a record of the transfer transaction.

Note that the scenario described in FIG. 8 is a combination between a remote transaction and a local transaction. In an alternate embodiment, the transfer of funds may have been between a remote transaction to an internal transaction. For example, a conventional debit card transfer may be used to fund an electronic purse on the integrated card 400. Alternately, in another embodiment, a local to internal transaction a merchant credit may be used to provide funds in an electronic purse of the integrated card 400 in a similar fashion.

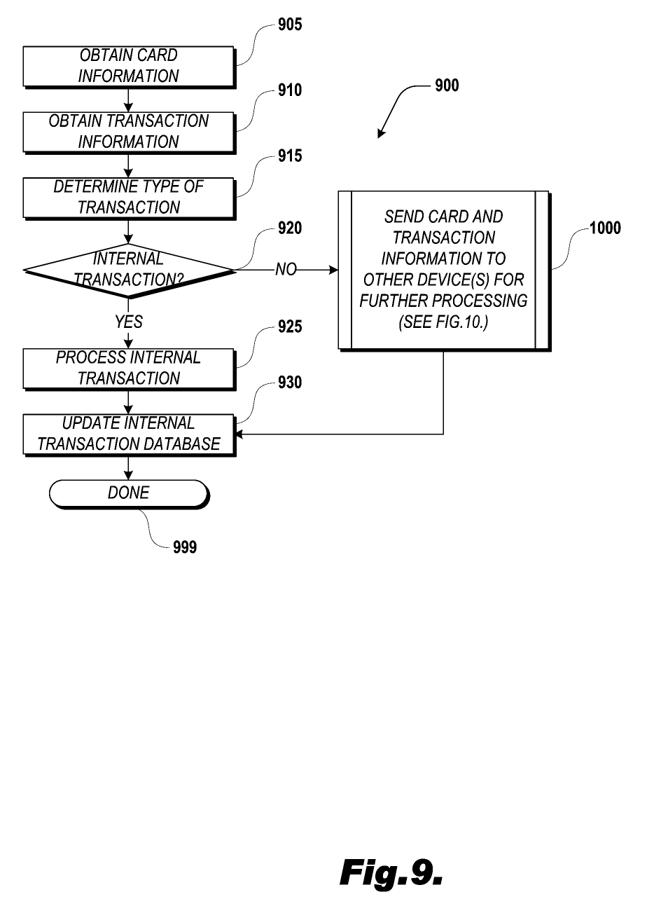

FIGS. 9-11 illustrate exemplary routines for handling internal, local and remote transactions as viewed from the card reader 300 and card-managing server 200.

FIG. 9 illustrates an exemplary card reader routine for processing card information. The card reader routine 900 begins at block 905 where card information is obtained. Next, in block 910, transaction information is obtained. As noted above, in some embodiments, transaction information may be implied or implicit from the card reader 300 and/or integrated card 400. In block 915, the type of transaction is determined. In decision block 920 a determination is made whether the transaction type is an internal transaction type (e.g., explicitly or by implication from card and/or transaction information). If so, processing continues to block 925 where the internal transaction is processed. Next, in block 930, an internal transaction database is updated and the card reader routine 900 ends at block 999.

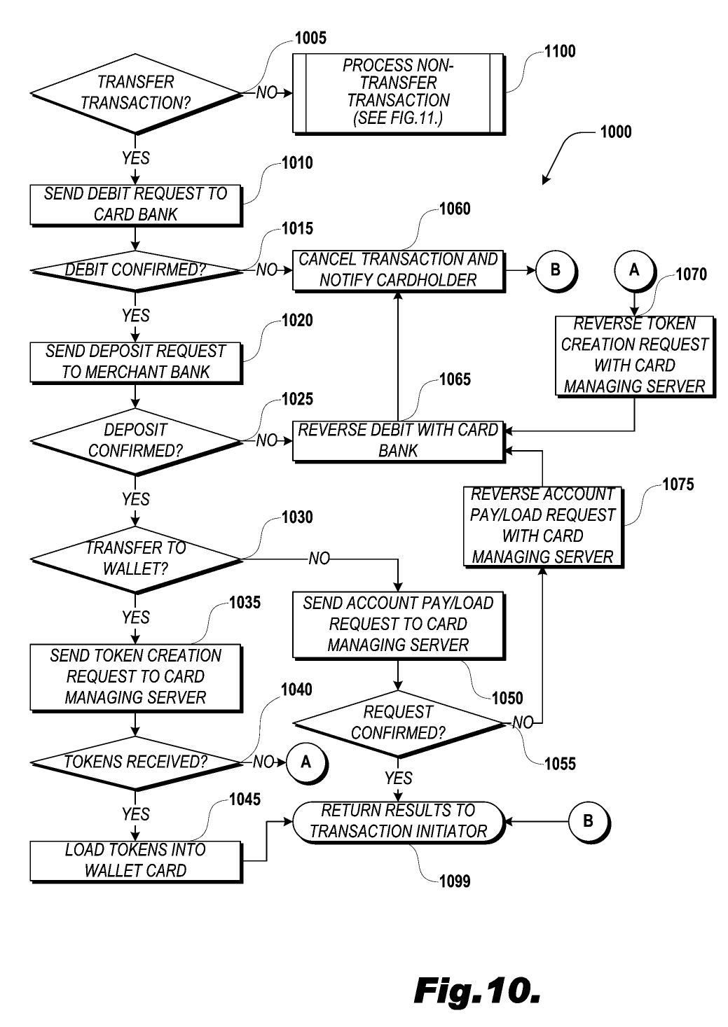

If, however, in decision blocks 920, it was determined that the transaction is not of an internal transaction type, processing proceeds to transaction routing subroutine block 1000 where the card and transaction information will be sent to other devices for further processing. Transaction routing subroutine 1000 is illustrated in FIG. 10 and described below. Upon returning from subroutine 1000, processing continues to block 930 where card reader routine 900 continues as described above.

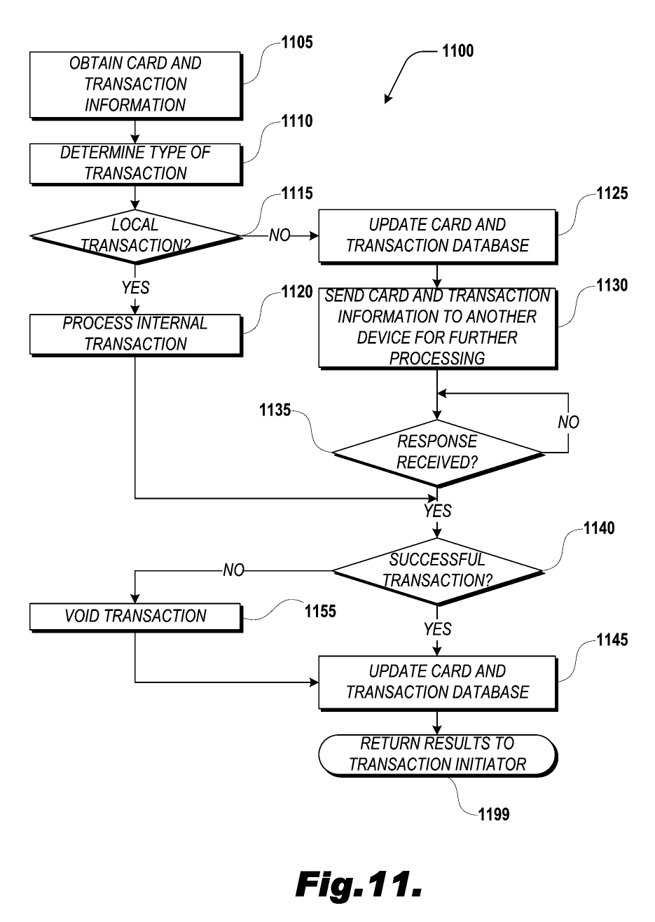

FIG. 10 illustrates an exemplary transaction routing subroutine 1000 for handling transactions that will communicate with other devices. Transaction routing subroutine 1000 begins at decision block 1005 where determination is made whether the transaction is a transfer transaction. If in decision block 1005 it was determined that this is not a transfer transaction then processing proceeds to the processing of transaction processing routine 1100 on the card-managing server 200. Transaction processing routine 1100 is illustrated in FIG. 11 and described below.

If in decision block 1005 it was determined that the transaction is a transfer transaction then processing proceeds to block 1010 where a debit request is sent to a card bank (e.g., card bank server 180). In various embodiments, multiple types of transfers, as described above, may be employed, however for illustrative purposes FIG. 10 describes transfer routines or transfers from a debit card account to either a local or an internal account (e.g., a merchant point account and an electronic purse respectively) of the integrated card 400.

In decision block 1015 a determination is made whether the debit was confirmed by the card bank. If the debit was confirmed, processing proceeds to block 1020 where a deposit request is sent to a merchant bank (e.g., merchant bank server 110). In decision block 1025 a determination is made whether the deposit was confirmed byt the merchant bank. If the deposit was confirmed in block 1025, processing proceeds to decision block 1030 where a determination was made whether to transfer to a wallet/electronic purse (e.g., internal account of the integrated card 400). If so, processing proceeds to block 1035 where a token creation request is sent to the card-managing server 200. In decision block 1040 a determination was made whether the tokens were received from the card-managing server 200. If the tokens were received, in block 1045 the tokens are loaded into an electronic purse of the integrated card 400 and routine 1000 returns the transaction results to the transaction initiator in block 1099. Note, that in alternate embodiments, a card reader may be able to issue tokens or otherwise replenish funds to an electronic purse of the integrated card 400.

If in decision block 1030, it was determined that the transfer was not a transfer to a wallet, the processing proceeds to block 1050 where an account pay/load request is sent to the card-managing server 200 (e.g., to pay for an existing credit balance or to load additional funds into a credit account managed by the card-managing server 200). In block 1055 a determination is made whether the pay/load request was confirmed. If so, processing proceeds to block 1099, where the results are returned to the transaction initiator.

If, however, back in decision block 1015, it was determined that the debit was not confirmed, processing proceeds to block 1060 where the transaction is cancelled and the cardholder is notified. Routine 1000 then ends at block 1099.

Similarly if in decision block 1025 it was determined that the deposit was not confirmed, processing proceeds to block 1065 where the debit is reversed at the card bank and processing proceeds to block 1060 as described above.

Additionally, if in decision block 1040 it was determined that no tokens were received, processing proceeds to block 1070 where the token creation request is reversed with the card-managing server 200 and processing proceeds to block 1065 as described above.

Likewise, if in decision block 1055 it was determined that the pay/load request was not confirmed, processing proceeds to block 1075 where the account pay/load request is reversed with the card-managing server and processing proceeds to block 1065 for processing as described above.

While a number of exemplary transfer scenarios are embodied in the FIG. 10 and associated description, in alternate embodiments transfers between different types of accounts (e.g., from the wallet to a card bank, from the credit account at a card-managing server 200 to the wallet and the like) may be implemented.

FIG. 11 illustrates an exemplary transaction processing routine 1100 at the card-managing server 200. Transaction processing routine 1100 begins at the block 1105 where card and transaction information is obtained from an initiating device (e.g., a card reader 300). In block 1110, the type of transaction is determined from the card and transaction information (possibly including implicit transaction information from a type of card reader 300 and/or integrated card 400).

In decision block 1115, a determination is made whether the transaction is a “local” transaction. If so, processing proceeds to block 1120, where the local transaction is processed by the card-managing server 200, after which processing proceeds to decision block 1140.

If, however, in decision block 1115, it was determined that the transaction is not a local transaction, processing proceeds to block 1125 where a card/transaction database 260 is updated (e.g., with a notation of the beginning of a transaction). In block 1130, card and transaction information are sent to another device for further processing. At block 1135, processing waits until a response has been received. Once the response has been received, as determined in decision block 1135, processing proceeds to decision block 1140, where determination is made whether the local or remote transaction was successful. If, in decision block 1140, it was determined that the transaction was successful, processing proceeds to block 1145, where the card/transaction database 260 is updated. If, however, in decision block 1140, it was determined that the transaction was not successful, processing proceeds to block 1155, where the transaction is voided. After block 1155, processing again returns to block 1145 where the card and transaction base are updated. Next, in block 1199 the results of the transaction are returned to the transaction initiator (e.g., the card reader 300).

In some embodiments it may be beneficial to integrate loadable debit cards with conventional banking transactions that are performed with conventional bank accounts. Accordingly, in some embodiments, a system (e.g., ACH system 1200) may be implemented that allows for financial network transactions in addition to the transactions performed over a debit network. One such alternate network is the ACH network.

The Automated Clearinghouse (“ACH”) Network is a system used by financial institutions to process millions of financial transactions each day. The system utilizes a network of ACH associations, of which many major banks are members. The transactions take place in a batch mode, by financial institutions transmitting payment instructions through the system of clearing houses. As the pace of electronic commerce quickens, and with the price advantages of ACH payments versus other payment mechanisms such as checks and wire transfers, the volume of ACH transactions will likely continue to increase.

One common form of ACH transactions for users is the ACH credit, which is the transaction type used for direct deposit of payroll. In that transaction, the employer is the Initiator of an ACH credit (the Payor) and the employee is the Receiver (the Payee) of that ACH credit. ACH debits are becoming more prevalent for users, with some adopters being health clubs who debit their members' bank accounts for club dues. In that transaction, the health club is the Initiator (the Payee) of the ACH debit, and the member being debited is the Receiver (the Payor).

The ACH System is governed by rules, policies and procedures written by The National Automated Clearing House Association (“NACHA”). Under current NACHA Rules, the Originator of an ACH debit (the payee) must have proper authorization from the Receiver of the ACH debit (the payor) before such a transaction can be initiated.

“Unauthorized” debits can be returned; however, the timeframe in which this must be done is varies. Users, on the other hand, have the protection of Regulation “E” and specific NACHA Rules relating to User accounts, which allow users to return ACH debit entries (that they document as “not authorized”) for an extended period after the original transaction date. There is also a service that allows review of ACH debits before they are posted, with the customer making the decision to accept or return the debit individually.

One specific type of ACH transaction of interest is a WEB ACH transaction. The WEB ACH transaction is a debit entry to a user bank account, for which the authorization was obtained from the Receiver (the user who owns the bank account) over the Internet. The specific designation for these types of transactions was created in order to address unique risks inherent to Internet payments.

Further details on the ACH system may be found in the 2005 ACH Operating Rules and Guidelines available from NACHA (National Automated Clearing House Association of Herndon, Va.), the entirety of which is hereby incorporated by reference. More specifically, multiple forms of ACH transactions are described therein that are suitable for use with various embodiments. An exemplary listing of transaction types (and ACH transaction codes) includes, but is not limited to:
(1) Accounts Receivable Entry (ARC)
(2) Consumer Cross-Border Payment (PBR)
(3) Card reader Entry (card reader)
(4) Prearranged Payment and Deposit Entry (PPD)
(5) Point-of-Purchase Entry (POP)
(6) Shared Network Entry (SHR)
(7) Telephone-initiated Entry (TEL)
(8) Internet-initiated Entry (WEB)
(9) ACH Payment Acknowledgment (ACK)
(10) Financial EDI Acknowledgment (ATX)
(11) Corporate Cross-Border Payment (CBR)
(12) Cash Disbursement (CCD)
(13) Cash Concentration (CCD)
(14) Corporate Trade Exchange (CTX)
(15) Customer-initiated Entry (CIE)
(16) Automated Accounting Advice (ADV)
(17) Automated Notification of Change (COR)
(18) Automated Return Entry (RET)
(19) Death Notification Entry (DNE)
(20) Automated Enrollment Entry (ENR)

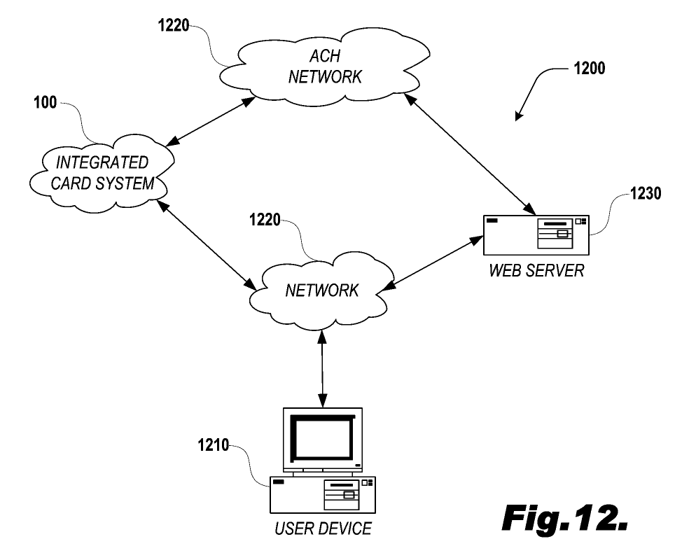

In a simplified overview of an ACH System 1200 for perform actions with integrated cards; FIG. 12 presents one exemplary embodiment of an ACH System 1200. FIG. 12 illustrates a user device 1210 connected via a network 1220 to a web server 1230 and a card system 100. Both the card system 100 and web server 1230 are connected to an ACH network 1220. In various embodiments, each loadable debit card contains a BIN (Bank Identification Number) which designates that specific cards account. Accordingly, this BIN may be used in some embodiments to determine where to route ACH transactions involving a loadable debit card. In one specific embodiment, the BIN is associated with a card system bank, but the BIN further includes an identification of the card system 100 such that the card bank 180 may intercept the processing of ACH transactions involving such specific BINS and forward them to the card system for additional processing.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein. Therefore, it is manifestly intended that this invention be limited only by the claims and the equivalents thereof.

1. An integrated card, comprising:
a substrate; and
a computer readable medium, the computer readable medium comprising:
computer readable information on for a plurality of integrated implicitly selectable card-accessible accounts, including: a conventional debit card account and a merchant credit account.

2. The integrated card of claim 1 further comprising computer readable access control information.

3. The integrated card of claim 2 further wherein said access control information is operative to operate a locking mechanism.

4. The integrated card of claim 1 further comprising a memory.

5. The integrated card of claim 4 wherein said memory contains electronic purse information.

6. The integrated card of claim 1 wherein integrated card has at least one accessible debit card account that is selected from the group consisting of:
VISA MasterCard, Discover, American Express, and Diners Club.

7. A computer-implemented method of processing a card transaction, the method comprising:
obtaining, in a predetermined type of card reader, information for one of a plurality of selectable card accessible accounts from an integrated card;
implicitly selecting a type of card transaction, selectable from at least a conventional debit card transaction and a credit card transaction; and
initiating a card transaction of said selected type.

8. The method of claim 7 wherein implicitly selecting further includes matching said selected type of transaction to relevant account information on said card.

9. The method of claim wherein implicitly selecting further includes automatically matching predetermined type of card reader to said account information.

10. A system for processing card transactions comprising:
an integrated card operative to store computer readable account information, and
a card reader device operative to obtain information from the integrated card, implicitly select the type of transaction to be initiated, and initiate the card transaction.

11. The system of claim 10, wherein said integrated card is further operative to store relevant transaction-type information.

12. The system of claim 11, wherein said card reader device is further operative to match relevant transaction-type information from said integrated card to the implicitly selected type of transaction.

13. The system of claim 10, wherein said card reader device is further operative to operate a locking mechanism.

14. The system of claim 10, further comprising one or more servers operative to
process transactions [and
store card and transaction information].

15. The system of claim 14, wherein said transactions are of at least one type selected from the group consisting of
credit card transactions
debit card transactions
ACH transactions.
